(19) United States
(12) Patent Application Publication
(10) Pub. No.: US 2021/0333018 A1
(43) Pub. Date: Oct. 28, 2021

(54) DOUBLE CHAMBERS BOILER SYSTEM WITH OXYGEN-ENRICHED COMBUSTION

(71) Applicant: UNIVERSITY OF SCIENCE AND TECHNOLOGY BEIJING, Beijing (CN)

(72) Inventors: Shengen Zhang, Beijing (CN); Bolin Zhang, Beijing (CN); Bo Liu, Beijing (CN); Lin Li, Beijing (CN)

(21) Appl. No.: 16/335,676

(22) PCT Filed: Nov. 30, 2017
(86) PCT No.: PCT/CN2017/113977

§ 371 Date: Mar. 22, 2019

(30) Foreign Application Priority Data
Nov. 29, 2017 (CN) 201711230671.7

(51) Int. Cl. F24H 9/20; F23C 9/06; F23L 7/00; F24H 1/00; F24H 1/18

(52) U.S. Cl. CPC F24H 9/2057; F23C 9/06; F23L 7/007; F24H 1/0063; F23L 2900/07005; F24H 1/187; F24H 9/2035; F23C 2202/20; F24H 1/0027

(57) ABSTRACT

A double chambers boiler system with oxygen-enriched combustion is provided, relating to fields of thermal power engineering and mechanical manufacturing. The double chambers boiler system includes a boiler furnace subassembly and a combustion control subassembly. The boiler furnace subassembly includes a combustion chamber and a heat exchange chamber. The heat exchange chamber is arranged above the combustion chamber. A high temperature flue gas outlet is arranged between the combustion chamber and the heat exchange chamber. The combustion control subassembly includes a burner, a pure oxygen injector and a fuel injector. The double chambers boiler system with oxygen-enriched combustion is able to simultaneously solve problems of improving a combustion efficiency and reducing an emission concentration of NOₓ.

### CROSS REFERENCE OF RELATED APPLICATION

This is a U.S. National Stage under 35 U.S.C 371 of the International Application PCT/CN2017/113977, filed Nov. 30, 2017, which claims priority under 35 U.S.C. 119(a-d) to CN 201711230671.7, filed Nov. 29, 2017.

### BACKGROUND OF THE PRESENT INVENTION

### Field of Invention

The present invention relates to technical fields of thermal power engineering and mechanical manufacturing, and more particularly to a double chambers boiler system with oxygen-enriched combustion.

### Description of Related Arts

Coal and petroleum are most important fuels in the world, accounting for above 60% of the global energy consumption. In 2016, the coal consumption in China is 1.887 billion tons of oil equivalent, wherein the electric power industry is the major industry of coal consumption and accounts for about 50% of the coal consumption every year. The consumption of fossil energy is mainly through combustion, and there are two challenges for the consumption of fossil energy. One is the efficiency of energy utilization, and the other is the pollutant emissions. In the boiler field, improving the fuel burnout rate and boiler thermal efficiency, as well as reducing the emission concentrations of NOₓ, SO₂ and CO₂, are problems should be solved by the boiler design.

Because of increasing the concentration of the combustion supporting oxygen, the oxygen-enriched combustion can improve the fuel burnout rate and meanwhile enrich CO₂ through recirculating the flue gas, which is beneficial to capturing of end CO₂ and is a good boiler improvement way. However, the high combustion temperature of the oxygen-enriched combustion facilitates generation of thermal NOₓ, leading to the greatly increased NOₓ emission concentration. Meanwhile, because of NOₓ and SO₂, the corrosions of the furnace, heating surface and flue gas pipeline become more severe.

The Chinese patent publication (CN 105605562A) disclosed a flue gas circulation system for an oxygen-enriched combustion boiler, which adjusts the ratio of oxygen to flue gas through adjusting the position of the oxygen injector, so as to realize optimization of efficiency of the oxygen-enriched combustion boiler. However, the emission problem of NOₓ is not mentioned in the above patent. The Chinese patent publication (CN 105276605A) disclosed a coal-fired boiler and a combustion method thereof. The water vapor is introduced into the main combustion zone of the combustor, so as to generate CO for reducing NOₓ and reduce the emission concentration of NOₓ. However, the above method will increase the emission concentration of CO, which indicates the decrease of the burnout rate. The Chinese patent publication (CN 103953921B) disclosed an oxygen-enriched combustion boiler system and an operation method thereof. The denitrification and desulfuration equipment is arranged at the tail flue gas pipeline, so as to avoid the enrichment problem of NOₓ and SO₂ during the circulation process of the flue gas; and the oxygen injection way is adjusted to increase the enrichment concentration of CO₂. Through the above method, the problem of NOₓ and SO₂ is controlled at the tail flue gas pipeline. However, the NOₓ generation problem during the oxygen-enriched combustion process still exists; the work is heavy; and the investment is huge.

In summary, there is a contradiction between improving the combustion efficiency and reducing the emission concentration of NOₓ for the common oxygen-enriched combustion.

### SUMMARY OF THE PRESENT INVENTION

For above technical problems, the present invention provides a double chambers boiler system with oxygen-enriched combustion, comprising a combustion chamber and a heat exchange chamber, wherein pure oxygen is adopted as a combustion supporting gas, so as to simultaneously solve problems of improving a combustion efficiency and reducing an emission concentration of NOₓ.

Technical solutions of the present invention are described as follows.

A double chambers boiler system with oxygen-enriched combustion comprises a boiler furnace subassembly and a combustion control subassembly, wherein the boiler furnace subassembly comprises a combustion chamber and a heat exchange chamber; the combustion chamber is for oxygen-enriched combustion of fuel, so as to generate high temperature flue gas; the heat exchange chamber is for transferring heat from the high temperature flue gas to a water wall or a boiler water wall pipe; the heat exchange chamber is arranged above the combustion chamber; a high temperature flue gas outlet is arranged between the combustion chamber and the heat exchange chamber; pure oxygen is adopted for supporting combustion; the combustion chamber is able to meet a high temperature resistance requirement for combustion in the pure oxygen; and the heat exchange chamber is able to realize a highly-efficient heat transfer of a boiler.

Preferably, the combustion control subassembly assists feeding of the fuel with CO₂ and/or flue gas recirculation and is equipped with a flue gas recirculation tube; according to a combustion effect in the combustion chamber, a ratio of CO₂ to flue gas and a ratio of fuel to pure oxygen which is a combustion supporting gas are able to be adjusted; the flue gas recirculation tube is for reusing of the flue gas; the combustion control subassembly comprises a burner, a pure oxygen injector and a fuel injector; the burner is connected to the combustion chamber; and, the pure oxygen injector and the fuel injector are both connected to the burner. The combustion control subassembly adopts CO₂ for feeding of the fuel and is equipped with the flue gas recirculation tube, so that a safety of fuel feeding is ensured and a flue gas recirculation ratio is able to be adjusted according to requirements.

Preferably, injection ports are arranged at a middle part of the combustion chamber and on a wall of the combustion chamber; the injection ports are arranged horizontally and symmetrically on a same plane, and 3-6 injection ports are arranged on the same plane; for the wall of the combustion chamber, an inner layer is made of high temperature refractory material, a middle layer is made of thermal insulation material, and an outer layer is made of structural material; and an ash bucket is arranged below the combustion chamber.

Preferably, the heat exchange chamber is intercommunicated with the combustion chamber through the high temperature flue gas outlet; a flue gas outlet of the heat exchange chamber is arranged at top of the heat exchange chamber; a waste heat recovery device is arranged outside the flue gas outlet of the heat exchange chamber; the water wall is an inner wall of the heat exchange chamber; and the boiler water wall pipe is arranged in middle of the heat exchange chamber.

Preferably, an economizer is arranged inside the waste heat recovery device; an end gas outlet is arranged at a tail end of the waste heat recovery device, and the end gas outlet is connected to a pre-heater.

Preferably, in the burner, in order to avoid explosion, primary air and secondary air are separately delivered; the primary air and the secondary air are sprayed into the combustion chamber by the burner; the primary air is air carrying the fuel, and the secondary air is the pure oxygen.

Preferably, a part of or all of the primary air is end gas exhausted from the waste heat recovery device; the end gas exhausted from the waste heat recovery device enters the fuel injector after passing through the pre-heater and processing with flue gas separation, wherein the end gas is induced by a first draught fan; then the primary air carrying the fuel enters the burner; herein, the fuel is fed by a fuel supply equipment;

when a part of the primary air is the end gas exhausted from the waste heat recovery device, the other part of the primary air is CO₂; CO₂ is induced by a second draught fan; the end gas and CO₂ respectively induced by the draught fans enter the fuel injector after passing through the pre-heater; and then the primary air carrying the fuel enters the burner; or

all of the primary air is CO₂; CO₂ induced by the second draught fan enters the fuel injector after passing through the pre-heater; and then the primary air carrying the fuel enters the burner; and

the secondary air is standard pure oxygen; after passing through the pre-heater, the standard pure oxygen induced by a third draught fan enters the burner through the pure oxygen injector.

Preferably, internal channels of the burner are arranged in structure of concentric circles or parallel channels, comprising an oxygen channel and a fuel channel, wherein: the oxygen channel and the fuel channel are separated from each other; the primary air carrying the fuel is sprayed into the combustion chamber through the fuel channel, and the secondary air enters the combustion chamber through the oxygen channel.

Preferably, the combustion control subassembly further comprises a detector for automatically monitoring concentrations of oxygen and CO₂ and a temperature, so that the ratio of CO₂ to flue gas and the ratio of fuel to pure oxygen which is the combustion supporting gas are able to be adjusted according to the combustion effect in the combustion chamber.

The present invention has following beneficial technical effects.

(1) According to the present invention, the combustion chamber of the double chambers boiler system with oxygen-enriched combustion meets the high temperature resistance requirement for combustion in the pure oxygen, which realizes the deep burnout of the fuel.

(2) According to the present invention, the double chambers boiler system with oxygen-enriched combustion comprises the separated heat exchange chamber, which realizes the highly-efficient heat transfer of the boiler.

(3) According to the present invention, the double chambers boiler system with oxygen-enriched combustion adopts the pure oxygen for supporting combustion, which prevents N₂ from entering the combustion chamber, avoids generation of the thermal NOₓ, and reduces the emission concentration of NOₓ.

(4) According to the present invention, the combustion control subassembly of the double chambers boiler system with oxygen-enriched combustion assists feeding of the fuel with CO₂ and flue gas recirculation, so that the safety of fuel feeding is ensured and the highly-efficient enrichment of CO₂ is realized.

### BRIEF DESCRIPTION OF THE DRAWINGS

The drawings illustrated herein are for providing further understanding of the present invention and constituting a part of the present invention, but not all of the present invention, which will not improperly limit the present invention.

FIG. 1 is a sketch view of a double chambers boiler system with oxygen-enriched combustion according to the present invention.

FIG. 2 is a sketch view of concentric arrangement of internal channels of a burner according to the present invention.

FIG. 3 is a sketch view of parallel arrangement of the internal channels of the burner according to the present invention.

In figures: 01: boiler furnace subassembly; 02: combustion chamber; 03: heat exchange chamber; 04: burner; 05: injection ports; 06: water wall; 07: wall of combustion chamber; 08: pure oxygen injector; 09: fuel injector; 10: high temperature flue gas outlet; 11: ash bucket; 12: boiler water wall pipe; 13: pre-heater; 14: end gas outlet; 15: flue gas outlet of heat exchange chamber; 16: fuel supply equipment; 17, 18 and 19: draught fans; 20: waste heat recovery device; 21: economizer; 22: combustion control subassembly; 23: flue gas recirculation tube; 24: detector; 201: oxygen channel; and 202: fuel channel.

### DETAILED DESCRIPTION OF THE PREFERRED EMBODIMENT

In order to make objects, technical solutions and advantages of the present invention more understandable and clearer, the present invention will be further described in detail with reference to the accompanying drawings and examples. It should be understood that the examples described herein are merely for explaining the present invention, not for limiting the present invention.

Moreover, replacements, modifications, equivalent methods and solutions, which are made within the spirit and scope of the present invention and defined by claims, are all encompassed in the protection scope of the present invention. In order to make the public better understand the present invention, in the following detailed description of the present invention, some specific details are described. One skilled in the art can fully understand the present invention without the specific details.

### Example 1

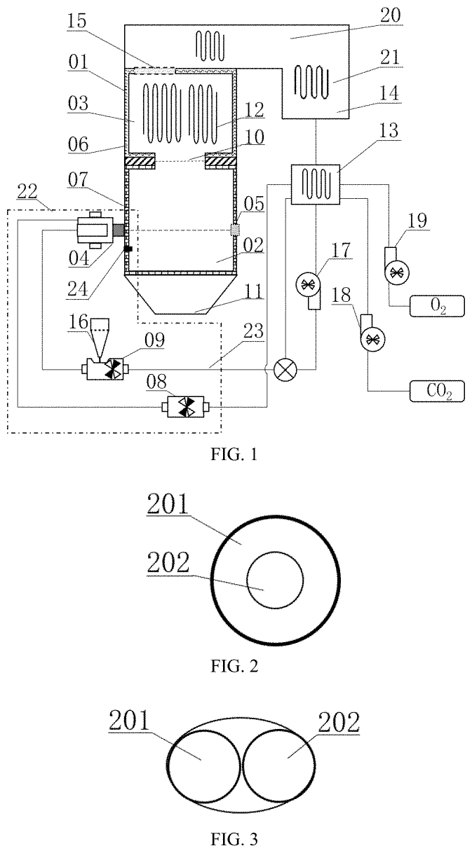

As shown in FIG. 1, a double chambers boiler system with oxygen-enriched combustion comprises a boiler furnace subassembly 01 and a combustion control subassembly 22; wherein: the boiler furnace subassembly 01 comprises a combustion chamber 02 and a heat exchange chamber 03; the combustion chamber 02 is a horizontal combustion chamber; the heat exchange chamber 03 is arranged above the horizontal combustion chamber 02; a high temperature flue gas outlet 10 is arranged between the combustion chamber 02 and the heat exchange chamber 03; and, the combustion control subassembly 22 comprises a burner 04, a pure oxygen injector 08 and a fuel injector 09.

An ash bucket 11 is arranged below the combustion chamber 02; three injection ports 05 are arranged at a middle part of the combustion chamber 02; and the high temperature flue gas outlet 10 is arranged at top of the combustion chamber 02. The injection ports 05 are arranged horizontally and symmetrically, namely in arrangement of equilateral triangle. For a wall 07 of the combustion chamber 02, an inner layer is made of high temperature refractory material, a middle layer is made of thermal insulation material, and an outer layer is made of structural material.

The heat exchange chamber 03 is intercommunicated with the combustion chamber 02 through the high temperature flue gas outlet 10; an inner wall of the heat exchange chamber 03 is a water wall 06; a boiler water wall pipe 12 is arranged in middle of the heat exchange chamber 03; a flue gas outlet 15 of the heat exchange chamber 03 is arranged at top of the heat exchange chamber 03; a waste heat recovery device 20 is arranged outside the flue gas outlet 15 of the heat exchange chamber 03; an economizer 21 is arranged in middle of the waste heat recovery device 20; an end gas outlet 14 is arranged at a tail end of the waste heat recovery device 20, and the end gas outlet 14 is connected to a pre-heater 13.

In the burner 04, in order to avoid explosion, primary air and secondary air are separately delivered; the primary air and the secondary air are sprayed into the combustion chamber 02 by the burner 04; the primary air is air carrying fuel, and the secondary air is pure oxygen;

a part of the primary air is end gas exhausted from the waste heat recovery device 20; the end gas exhausted from the waste heat recovery device 20 enters the fuel injector 09 after passing through the pre-heater 13 and processing with flue gas separation, wherein the end gas is induced by a draught fan 17; the other part of the primary air is CO₂; CO₂ induced by a draught fan 18 enters the fuel injector 09 after passing through the pre-heater 13; and then the primary air enters the burner 04 with carrying the fuel of the fuel injector 09; herein, the fuel is fed by a fuel supply equipment 16; and

the secondary air is standard pure oxygen; after passing through the pre-heater 13, the standard pure oxygen induced by a draught fan 19 enters the burner 04 through the pure oxygen injector 08.

As shown in FIG. 2, internal channels of the burner 04 are arranged in structure of concentric circles, comprising a fuel channel 202 and an oxygen channel 201, wherein: the oxygen channel 201 is arranged outside the fuel channel 202; the two channels are in structure of concentric circles; the fuel channel 202 and the oxygen channel 201 are separated from each other; the primary air carrying the fuel is sprayed into the combustion chamber 02 through the fuel channel 202, and the secondary air enters the combustion chamber 02 through the oxygen channel 201.

The combustion control subassembly 22 further comprises a detector 24 for automatically monitoring concentrations of oxygen and CO₂ and a temperature, so that a ratio of CO₂ to flue gas and a ratio of fuel to pure oxygen which is a combustion supporting gas are able to be adjusted according to a combustion effect.

### Example 2

A double chambers boiler system with oxygen-enriched combustion comprises a boiler furnace subassembly 01 and a combustion control subassembly 22; wherein: the boiler furnace subassembly 01 comprises a combustion chamber 02 and a heat exchange chamber 03; the combustion chamber 02 is a horizontal combustion chamber; the heat exchange chamber 03 is arranged above the horizontal combustion chamber 02; a high temperature flue gas outlet 10 is arranged between the combustion chamber 02 and the heat exchange chamber 03; and, the combustion control subassembly 22 comprises a burner 04, a pure oxygen injector 08 and a fuel injector 09.

An ash bucket 11 is arranged below the combustion chamber 02; three injection ports 05 are arranged at a middle part of the combustion chamber 02; and the high temperature flue gas outlet 10 is arranged at top of the combustion chamber 02. The injection ports 05 are arranged horizontally and symmetrically, namely in arrangement of equilateral triangle. For a wall 07 of the combustion chamber 02, an inner layer is made of high temperature refractory material, a middle layer is made of thermal insulation material, and an outer layer is made of structural material.

The heat exchange chamber 03 is intercommunicated with the combustion chamber 02 through the high temperature flue gas outlet 10; an inner wall of the heat exchange chamber 03 is a water wall 06; a boiler water wall pipe 12 is arranged in middle of the heat exchange chamber 03; a flue gas outlet 15 of the heat exchange chamber 03 is arranged at top of the heat exchange chamber 03; a waste heat recovery device 20 is arranged outside the flue gas outlet 15 of the heat exchange chamber 03; an economizer 21 and a heat exchanger are arranged in middle of the waste heat recovery device 20; an end gas outlet 14 is arranged at a tail end of the waste heat recovery device 20, and the end gas outlet 14 is connected to a pre-heater 13.

In the burner 04, in order to avoid explosion, primary air and secondary air are separately delivered; the primary air and the secondary air are sprayed into the combustion chamber 02 by the burner 04; the primary air is air carrying fuel, and the secondary air is pure oxygen;

all of the primary air is end gas exhausted from the waste heat recovery device 20; the end gas exhausted from the waste heat recovery device 20 enters the fuel injector 09 after passing through the pre-heater 13 and processing with flue gas separation, wherein the end gas is induced by a draught fan 17; and then the primary air enters the burner 04 with carrying the fuel of the fuel injector 09; herein, the fuel is fed by a fuel supply equipment 16; and

the secondary air is standard pure oxygen; after passing through the pre-heater 13, the standard pure oxygen induced by a draught fan 19 enters the burner 04 through the pure oxygen injector 08.

The burner 04 comprises a fuel channel 202 and an oxygen channel 201, wherein: the fuel channel 202 and the oxygen channel 201 are arranged in parallel as shown in FIG. 3; the primary air carrying the fuel enters the burner 04 through the fuel channel 202, and the secondary air enters the burner 04 through the oxygen channel 201.

The combustion control subassembly 22 further comprises a detector 24 for automatically monitoring concentrations of oxygen and CO₂ and a temperature, so that a ratio of CO₂ to flue gas and a ratio of fuel to pure oxygen which is a combustion supporting gas are able to be adjusted according to a combustion effect.

### Example 3

A double chambers boiler system with oxygen-enriched combustion comprises a boiler furnace subassembly 01 and a combustion control subassembly 22; wherein: the boiler furnace subassembly 01 comprises a combustion chamber 02 and a heat exchange chamber 03; the combustion chamber 02, which is a horizontal combustion chamber, is arranged at a lower part of the boiler furnace subassembly 01, and the heat exchange chamber 03 is arranged at an upper part of the boiler furnace subassembly 01; a high temperature flue gas outlet 10 is arranged between the combustion chamber 02 and the heat exchange chamber 03; and, the combustion control subassembly 22 comprises a burner 04, a pure oxygen injector 08 and a fuel injector 09.

An ash bucket 11 is arranged below the combustion chamber 02; four injection ports 05 are arranged at a middle part of the combustion chamber 02; and the high temperature flue gas outlet 10 is arranged at top of the combustion chamber 02. The injection ports 05 are arranged horizontally and symmetrically. For a wall 07 of the combustion chamber 02, an inner layer is made of high temperature refractory material, a middle layer is made of thermal insulation material, and an outer layer is made of structural material.

The heat exchange chamber 03 is intercommunicated with the combustion chamber 02 through the high temperature flue gas outlet 10; an inner wall of the heat exchange chamber 03 is a water wall 06; a boiler water wall pipe 12 is arranged in middle of the heat exchange chamber 03; a flue gas outlet 15 of the heat exchange chamber 03 is arranged at top of the heat exchange chamber 03; a waste heat recovery device 20 is arranged outside the flue gas outlet 15 of the heat exchange chamber 03; an economizer 21 is arranged in middle of the waste heat recovery device 20; an end gas outlet 14 is arranged at a tail end of the waste heat recovery device 20, and the end gas outlet 14 is connected to a pre-heater 13.

In the burner 04, in order to avoid explosion, primary air and secondary air are separately delivered; the primary air and the secondary air are sprayed into the combustion chamber 02 by the burner 04; the primary air is air carrying fuel, and the secondary air is pure oxygen;

all of the primary air is CO₂; CO₂ induced by a draught fan 18 enters the fuel injector 09 after passing through the pre-heater 13; and then the primary air enters the burner 04 with carrying the fuel of the fuel injector 09; herein, the fuel is fed by a fuel supply equipment 16; and

the secondary air is standard pure oxygen; after passing through the pre-heater 13, the standard pure oxygen induced by a draught fan 19 enters the burner 04 through the pure oxygen injector 08.

The combustion control subassembly 22 further comprises a detector 24 for automatically monitoring concentrations of oxygen and CO₂ and a temperature, so that a ratio of CO₂ to flue gas and a ratio of fuel to pure oxygen which is a combustion supporting gas are able to be adjusted according to a combustion effect.

### Example 4

A double chambers boiler system with oxygen-enriched combustion comprises a boiler furnace subassembly 01 and a combustion control subassembly 22; wherein: the boiler furnace subassembly 01 comprises a combustion chamber 02 and a heat exchange chamber 03; the combustion chamber 02, which is a horizontal combustion chamber, is arranged at a lower part of the boiler furnace subassembly 01, and the heat exchange chamber 03 is arranged at an upper part of the boiler furnace subassembly 01; a high temperature flue gas outlet 10 is arranged between the combustion chamber 02 and the heat exchange chamber 03; and, the combustion control subassembly 22 comprises a burner 04, a pure oxygen injector 08 and a fuel injector 09.

An ash bucket 11 is arranged below the combustion chamber 02; four injection ports 05 are arranged at a middle part of the combustion chamber 02; and the high temperature flue gas outlet 10 is arranged at top of the combustion chamber 02. The injection ports 05 are arranged horizontally and symmetrically. For a wall 07 of the combustion chamber 02, an inner layer is made of high temperature refractory material, a middle layer is made of thermal insulation material, and an outer layer is made of structural material.

The heat exchange chamber 03 is intercommunicated with the combustion chamber 02 through the high temperature flue gas outlet 10; an inner wall of the heat exchange chamber 03 is a water wall 06; a boiler water wall pipe 12 is arranged in middle of the heat exchange chamber 03; a flue gas outlet 15 of the heat exchange chamber 03 is arranged at top of the heat exchange chamber 03; a waste heat recovery device 20 is arranged outside the flue gas outlet 15 of the heat exchange chamber 03; an economizer 21 and a heat exchanger are arranged in middle of the waste heat recovery device 20; an end gas outlet 14 is arranged at a tail end of the waste heat recovery device 20, and the end gas outlet 14 is connected to a pre-heater 13.

In the burner 04, in order to avoid explosion, primary air and secondary air are separately delivered; the primary air and the secondary air are sprayed into the combustion chamber 02 by the burner 04; the primary air is air carrying fuel, and the secondary air is pure oxygen;

a part of the primary air is end gas exhausted from the waste heat recovery device 20; the end gas exhausted from the waste heat recovery device 20 enters the fuel injector 09 after passing through the pre-heater 13 and processing with flue gas separation, wherein the end gas is induced by a draught fan 17; the other part of the primary air is CO₂; CO₂ induced by a draught fan 18 enters the fuel injector 09 after passing through the pre-heater 13; and then the primary air enters the burner 04 with carrying the fuel of the fuel injector 09; herein, the fuel is fed by a fuel supply equipment 16; and

the secondary air is standard pure oxygen; after passing through the pre-heater 13, the standard pure oxygen induced by a draught fan 19 enters the burner 04 through the pure oxygen injector 08.

The combustion control subassembly 22 further comprises a detector 24 for automatically monitoring concentrations of oxygen and CO₂ and a temperature, so that a ratio of CO₂ to flue gas and a ratio of fuel to pure oxygen which is a combustion supporting gas are able to be adjusted according to a combustion effect.

### Example 5

A double chambers boiler system with oxygen-enriched combustion comprises a boiler furnace subassembly 01 and a combustion control subassembly 22; wherein: the boiler furnace subassembly 01 comprises a combustion chamber 02 and a heat exchange chamber 03; the combustion chamber 02, which is a horizontal combustion chamber, is arranged at a lower part of the boiler furnace subassembly 01, and the heat exchange chamber 03 is arranged at an upper part of the boiler furnace subassembly 01; a high temperature flue gas outlet 10 is arranged between the combustion chamber 02 and the heat exchange chamber 03; and, the combustion control subassembly 22 comprises a burner 04, a pure oxygen injector 08 and a fuel injector 09.

An ash bucket 11 is arranged below the combustion chamber 02; five injection ports 05 are arranged at a middle part of the combustion chamber 02; and the high temperature flue gas outlet 10 is arranged at top of the combustion chamber 02. The injection ports 05 are arranged horizontally and symmetrically. For a wall 07 of the combustion chamber 02, an inner layer is made of high temperature refractory material, a middle layer is made of thermal insulation material, and an outer layer is made of structural material.

The heat exchange chamber 03 is intercommunicated with the combustion chamber 02 through the high temperature flue gas outlet 10; an inner wall of the heat exchange chamber 03 is a water wall 06; a boiler water wall pipe 12 is arranged in middle of the heat exchange chamber 03; a flue gas outlet 15 of the heat exchange chamber 03 is arranged at top of the heat exchange chamber 03; a waste heat recovery device 20 is arranged outside the flue gas outlet 15 of the heat exchange chamber 03; an economizer 21 is arranged in middle of the waste heat recovery device 20; an end gas outlet 14 is arranged at a tail end of the waste heat recovery device 20, and the end gas outlet 14 is connected to a pre-heater 13.

In the burner 04, in order to avoid explosion, primary air and secondary air are separately delivered; the primary air and the secondary air are sprayed into the combustion chamber 02 by the burner 04; the primary air is air carrying fuel, and the secondary air is pure oxygen;

all of the primary air is end gas exhausted from the waste heat recovery device 20; the end gas exhausted from the waste heat recovery device 20 enters the fuel injector 09 after passing through the pre-heater 13 and processing with flue gas separation, wherein the end gas is induced by a draught fan 17; and then the primary air enters the burner 04 with carrying the fuel of the fuel injector 09; herein, the fuel is fed by a fuel supply equipment 16; and

the secondary air is standard pure oxygen; after passing through the pre-heater 13, the standard pure oxygen induced by a draught fan 19 enters the burner 04 through the pure oxygen injector 08.

The combustion control subassembly 22 further comprises a detector 24 for automatically monitoring concentrations of oxygen and CO₂ and a temperature, so that a ratio of CO₂ to flue gas and a ratio of fuel to pure oxygen which is a combustion supporting gas are able to be adjusted according to a combustion effect.

### Example 6

A double chambers boiler system with oxygen-enriched combustion comprises a boiler furnace subassembly 01 and a combustion control subassembly 22; wherein: the boiler furnace subassembly 01 comprises a combustion chamber 02 and a heat exchange chamber 03; the combustion chamber 02, which is a horizontal combustion chamber, is arranged at a lower part of the boiler furnace subassembly 01, and the heat exchange chamber 03 is arranged at an upper part of the boiler furnace subassembly 01; a high temperature flue gas outlet 10 is arranged between the combustion chamber 02 and the heat exchange chamber 03; and, the combustion control subassembly 22 comprises a burner 04, a pure oxygen injector 08 and a fuel injector 09.

An ash bucket 11 is arranged below the combustion chamber 02; five injection ports 05 are arranged at a middle part of the combustion chamber 02; and the high temperature flue gas outlet 10 is arranged at top of the combustion chamber 02. The injection ports 05 are arranged horizontally and symmetrically. For a wall 07 of the combustion chamber 02, an inner layer is made of high temperature refractory material, a middle layer is made of thermal insulation material, and an outer layer is made of structural material.

The heat exchange chamber 03 is intercommunicated with the combustion chamber 02 through the high temperature flue gas outlet 10; an inner wall of the heat exchange chamber 03 is a water wall 06; a boiler water wall pipe 12 is arranged in middle of the heat exchange chamber 03; a flue gas outlet 15 of the heat exchange chamber 03 is arranged at top of the heat exchange chamber 03; a waste heat recovery device 20 is arranged outside the flue gas outlet 15 of the heat exchange chamber 03; an economizer 21 and a heat exchanger are arranged in middle of the waste heat recovery device 20; an end gas outlet 14 is arranged at a tail end of the waste heat recovery device 20, and the end gas outlet 14 is connected to a pre-heater 13.

In the burner 04, in order to avoid explosion, primary air and secondary air are separately delivered; the primary air and the secondary air are sprayed into the combustion chamber 02 by the burner 04; the primary air is air carrying fuel, and the secondary air is pure oxygen;

all of the primary air is CO₂; CO₂ induced by a draught fan 18 enters the fuel injector 09 after passing through the pre-heater 13; and then the primary air enters the burner 04 with carrying the fuel of the fuel injector 09; herein, the fuel is fed by a fuel supply equipment 16; and

the secondary air is standard pure oxygen; after passing through the pre-heater 13, the standard pure oxygen induced by a draught fan 19 enters the burner 04 through the pure oxygen injector 08.

The combustion control subassembly 22 further comprises a detector 24 for automatically monitoring concentrations of oxygen and CO₂ and a temperature, so that a ratio of CO₂ to flue gas and a ratio of fuel to pure oxygen which is a combustion supporting gas are able to be adjusted according to a combustion effect.

### Example 7

A double chambers boiler system with oxygen-enriched combustion comprises a boiler furnace subassembly 01 and a combustion control subassembly 22; wherein: the boiler furnace subassembly 01 comprises a combustion chamber 02 and a heat exchange chamber 03; the combustion chamber 02, which is a horizontal combustion chamber, is arranged at a lower part of the boiler furnace subassembly 01, and the heat exchange chamber 03 is arranged at an upper part of the boiler furnace subassembly 01; a high temperature flue gas outlet 10 is arranged between the combustion chamber 02 and the heat exchange chamber 03; and, the combustion control subassembly 22 comprises a burner 04, a pure oxygen injector 08 and a fuel injector 09.

An ash bucket 11 is arranged below the combustion chamber 02; six injection ports 05 are arranged at a middle part of the combustion chamber 02; and the high temperature flue gas outlet 10 is arranged at top of the combustion chamber 02. The injection ports 05 are arranged horizontally and symmetrically. For a wall 07 of the combustion chamber 02, an inner layer is made of high temperature refractory material, a middle layer is made of thermal insulation material, and an outer layer is made of structural material.

The heat exchange chamber 03 is intercommunicated with the combustion chamber 02 through the high temperature flue gas outlet 10; an inner wall of the heat exchange chamber 03 is a water wall 06; a boiler water wall pipe 12 is arranged in middle of the heat exchange chamber 03; a flue gas outlet 15 of the heat exchange chamber 03 is arranged at top of the heat exchange chamber 03; a waste heat recovery device 20 is arranged outside the flue gas outlet 15 of the heat exchange chamber 03; an economizer 21 is arranged in middle of the waste heat recovery device 20; an end gas outlet 14 is arranged at a tail end of the waste heat recovery device 20, and the end gas outlet 14 is connected to a pre-heater 13.

In the burner 04, in order to avoid explosion, primary air and secondary air are separately delivered; the primary air and the secondary air are sprayed into the combustion chamber 02 by the burner 04; the primary air is air carrying fuel, and the secondary air is pure oxygen;

a part of the primary air is end gas exhausted from the waste heat recovery device 20; the end gas exhausted from the waste heat recovery device 20 enters the fuel injector 09 after passing through the pre-heater 13 and processing with flue gas separation, wherein the end gas is induced by a draught fan 17; the other part of the primary air is CO₂; CO₂ induced by a draught fan 18 enters the fuel injector 09 after passing through the pre-heater 13; and then the primary air enters the burner 04 with carrying the fuel of the fuel injector 09; herein, the fuel is fed by a fuel supply equipment 16; and

the secondary air is standard pure oxygen; after passing through the pre-heater 13, the standard pure oxygen induced by a draught fan 19 enters the burner 04 through the pure oxygen injector 08.

The combustion control subassembly 22 further comprises a detector 24 for automatically monitoring concentrations of oxygen and CO₂ and a temperature, so that a ratio of CO₂ to flue gas and a ratio of fuel to pure oxygen which is a combustion supporting gas are able to be adjusted according to a combustion effect.

### Example 8

A double chambers boiler system with oxygen-enriched combustion comprises a boiler furnace subassembly 01 and a combustion control subassembly 22; wherein: the boiler furnace subassembly 01 comprises a combustion chamber 02 and a heat exchange chamber 03; the combustion chamber 02, which is a horizontal combustion chamber, is arranged at a lower part of the boiler furnace subassembly 01, and the heat exchange chamber 03 is arranged at an upper part of the boiler furnace subassembly 01; a high temperature flue gas outlet 10 is arranged between the combustion chamber 02 and the heat exchange chamber 03; and, the combustion control subassembly 22 comprises a burner 04, a pure oxygen injector 08 and a fuel injector 09.

An ash bucket 11 is arranged below the combustion chamber 02; six injection ports 05 are arranged at a middle part of the combustion chamber 02; and the high temperature flue gas outlet 10 is arranged at top of the combustion chamber 02. The injection ports 05 are arranged horizontally and symmetrically. For a wall 07 of the combustion chamber 02, an inner layer is made of high temperature refractory material, a middle layer is made of thermal insulation material, and an outer layer is made of structural material.

The heat exchange chamber 03 is intercommunicated with the combustion chamber 02 through the high temperature flue gas outlet 10; an inner wall of the heat exchange chamber 03 is a water wall 06; a boiler water wall pipe 12 is arranged in middle of the heat exchange chamber 03; a flue gas outlet 15 of the heat exchange chamber 03 is arranged at top of the heat exchange chamber 03; a waste heat recovery device 20 is arranged outside the flue gas outlet 15 of the heat exchange chamber 03; an economizer 21 and a heat exchanger are arranged in middle of the waste heat recovery device 20; an end gas outlet 14 is arranged at a tail end of the waste heat recovery device 20, and the end gas outlet 14 is connected to a pre-heater 13.

In the burner 04, in order to avoid explosion, primary air and secondary air are separately delivered; the primary air and the secondary air are sprayed into the combustion chamber 02 by the burner 04; the primary air is air carrying fuel, and the secondary air is pure oxygen;

all of the primary air is end gas exhausted from the waste heat recovery device 20; the end gas exhausted from the waste heat recovery device 20 enters the fuel injector 09 after passing through the pre-heater 13 and processing with flue gas separation, wherein the end gas is induced by a draught fan 17; and then the primary air enters the burner 04 with carrying the fuel of the fuel injector 09; herein, the fuel is fed by a fuel supply equipment 16; and

the secondary air is standard pure oxygen; after passing through the pre-heater 13, the standard pure oxygen induced by a draught fan 19 enters the burner 04 through the pure oxygen injector 08.

The combustion control subassembly 22 further comprises a detector 24 for automatically monitoring concentrations of oxygen and CO₂ and a temperature, so that a ratio of CO₂ to flue gas and a ratio of fuel to pure oxygen which is a combustion supporting gas are able to be adjusted according to a combustion effect.

### Example 9

A double chambers boiler system with oxygen-enriched combustion comprises a boiler furnace subassembly 01 and a combustion control subassembly 22; wherein: the boiler furnace subassembly 01 comprises a combustion chamber 02 and a heat exchange chamber 03; the combustion chamber 02, which is a standing combustion chamber, is arranged at a lower part of the boiler furnace subassembly 01, and the heat exchange chamber 03 is arranged at an upper part of the boiler furnace subassembly 01; a high temperature flue gas outlet 10 is arranged between the combustion chamber 02 and the heat exchange chamber 03; and, the combustion control subassembly 22 comprises a burner 04, a pure oxygen injector 08 and a fuel injector 09.

An ash bucket 11 is arranged below the combustion chamber 02; three injection ports 05 are arranged at a middle part of the combustion chamber 02; and the high temperature flue gas outlet 10 is arranged at top of the combustion chamber 02. The injection ports 05 are arranged horizontally and symmetrically. For a wall 07 of the combustion chamber 02, an inner layer is made of high temperature refractory material, a middle layer is made of thermal insulation material, and an outer layer is made of structural material.

The heat exchange chamber 03 is intercommunicated with the combustion chamber 02 through the high temperature flue gas outlet 10; an inner wall of the heat exchange chamber 03 is a water wall 06; a boiler water wall pipe 12 is arranged in middle of the heat exchange chamber 03; a flue gas outlet 15 of the heat exchange chamber 03 is arranged at top of the heat exchange chamber 03; a waste heat recovery device 20 is arranged outside the flue gas outlet 15 of the heat exchange chamber 03; an economizer 21 is arranged in middle of the waste heat recovery device 20; an end gas outlet 14 is arranged at a tail end of the waste heat recovery device 20, and the end gas outlet 14 is connected to a pre-heater 13.

In the burner 04, in order to avoid explosion, primary air and secondary air are separately delivered; the primary air and the secondary air are sprayed into the combustion chamber 02 by the burner 04; the primary air is air carrying fuel, and the secondary air is pure oxygen;

all of the primary air is CO₂; CO₂ induced by a draught fan 18 enters the fuel injector 09 after passing through the pre-heater 13; and then the primary air enters the burner 04 with carrying the fuel of the fuel injector 09; herein, the fuel is fed by a fuel supply equipment 16; and

the secondary air is standard pure oxygen; after passing through the pre-heater 13, the standard pure oxygen induced by a draught fan 19 enters the burner 04 through the pure oxygen injector 08.

The combustion control subassembly 22 further comprises a detector 24 for automatically monitoring concentrations of oxygen and CO₂ and a temperature, so that a ratio of CO₂ to flue gas and a ratio of fuel to pure oxygen which is a combustion supporting gas are able to be adjusted according to a combustion effect.

### Example 10

A double chambers boiler system with oxygen-enriched combustion comprises a boiler furnace subassembly 01 and a combustion control subassembly 22; wherein: the boiler furnace subassembly 01 comprises a combustion chamber 02 and a heat exchange chamber 03; the combustion chamber 02, which is a standing combustion chamber, is arranged at a lower part of the boiler furnace subassembly 01, and the heat exchange chamber 03 is arranged at an upper part of the boiler furnace subassembly 01; a high temperature flue gas outlet 10 is arranged between the combustion chamber 02 and the heat exchange chamber 03; and, the combustion control subassembly 22 comprises a burner 04, a pure oxygen injector 08 and a fuel injector 09.

An ash bucket 11 is arranged below the combustion chamber 02; three injection ports 05 are arranged at a middle part of the combustion chamber 02; and the high temperature flue gas outlet 10 is arranged at top of the combustion chamber 02. The injection ports 05 are arranged horizontally and symmetrically, namely in arrangement of equilateral triangle. For a wall 07 of the combustion chamber 02, an inner layer is made of high temperature refractory material, a middle layer is made of thermal insulation material, and an outer layer is made of structural material.

The heat exchange chamber 03 is intercommunicated with the combustion chamber 02 through the high temperature flue gas outlet 10; an inner wall of the heat exchange chamber 03 is a water wall 06; a boiler water wall pipe 12 is arranged in middle of the heat exchange chamber 03; a flue gas outlet 15 of the heat exchange chamber 03 is arranged at top of the heat exchange chamber 03; a waste heat recovery device 20 is arranged outside the flue gas outlet 15 of the heat exchange chamber 03; an economizer 21 and a heat exchanger are arranged in middle of the waste heat recovery device 20; an end gas outlet 14 is arranged at a tail end of the waste heat recovery device 20, and the end gas outlet 14 is connected to a pre-heater 13.

In the burner 04, in order to avoid explosion, primary air and secondary air are separately delivered; the primary air and the secondary air are sprayed into the combustion chamber 02 by the burner 04; the primary air is air carrying fuel, and the secondary air is pure oxygen;

a part of the primary air is end gas exhausted from the waste heat recovery device 20; the end gas exhausted from the waste heat recovery device 20 enters the fuel injector 09 after passing through the pre-heater 13 and processing with flue gas separation, wherein the end gas is induced by a draught fan 17; the other part of the primary air is CO₂; CO₂ induced by a draught fan 18 enters the fuel injector 09 after passing through the pre-heater 13; and then the primary air enters the burner 04 with carrying the fuel of the fuel injector 09; herein, the fuel is fed by a fuel supply equipment 16; and the secondary air is standard pure oxygen; after passing through the pre-heater 13, the standard pure oxygen induced by a draught fan 19 enters the burner 04 through the pure oxygen injector 08.

The combustion control subassembly 22 further comprises a detector 24 for automatically monitoring concentrations of oxygen and CO₂ and a temperature, so that a ratio of CO₂ to flue gas and a ratio of fuel to pure oxygen which is a combustion supporting gas are able to be adjusted according to a combustion effect.

### Example 11

A double chambers boiler system with oxygen-enriched combustion comprises a boiler furnace subassembly 01 and a combustion control subassembly 22; wherein: the boiler furnace subassembly 01 comprises a combustion chamber 02 and a heat exchange chamber 03; the combustion chamber 02, which is a standing combustion chamber, is arranged at a lower part of the boiler furnace subassembly 01, and the heat exchange chamber 03 is arranged at an upper part of the boiler furnace subassembly 01; a high temperature flue gas outlet 10 is arranged between the combustion chamber 02 and the heat exchange chamber 03; and, the combustion control subassembly 22 comprises a burner 04, a pure oxygen injector 08 and a fuel injector 09.

An ash bucket 11 is arranged below the combustion chamber 02; four injection ports 05 are arranged at a middle part of the combustion chamber 02; and the high temperature flue gas outlet 10 is arranged at top of the combustion chamber 02. The injection ports 05 are arranged horizontally and symmetrically. For a wall 07 of the combustion chamber 02, an inner layer is made of high temperature refractory material, a middle layer is made of thermal insulation material, and an outer layer is made of structural material.

The heat exchange chamber 03 is intercommunicated with the combustion chamber 02 through the high temperature flue gas outlet 10; an inner wall of the heat exchange chamber 03 is a water wall 06; a boiler water wall pipe 12 is arranged in middle of the heat exchange chamber 03; a flue gas outlet 15 of the heat exchange chamber 03 is arranged at top of the heat exchange chamber 03; a waste heat recovery device 20 is arranged outside the flue gas outlet 15 of the heat exchange chamber 03; an economizer 21 is arranged in middle of the waste heat recovery device 20; an end gas outlet 14 is arranged at a tail end of the waste heat recovery device 20, and the end gas outlet 14 is connected to a pre-heater 13.

In the burner 04, in order to avoid explosion, primary air and secondary air are separately delivered; the primary air and the secondary air are sprayed into the combustion chamber 02 by the burner 04; the primary air is air carrying fuel, and the secondary air is pure oxygen;

all of the primary air is end gas exhausted from the waste heat recovery device 20; the end gas exhausted from the waste heat recovery device 20 enters the fuel injector 09 after passing through the pre-heater 13 and processing with flue gas separation, wherein the end gas is induced by a draught fan 17; and then the primary air enters the burner 04 with carrying the fuel of the fuel injector 09; herein, the fuel is fed by a fuel supply equipment 16; and

the secondary air is standard pure oxygen; after passing through the pre-heater 13, the standard pure oxygen induced by a draught fan 19 enters the burner 04 through the pure oxygen injector 08.

The combustion control subassembly 22 further comprises a detector 24 for automatically monitoring concentrations of oxygen and CO₂ and a temperature, so that a ratio of CO₂ to flue gas and a ratio of fuel to pure oxygen which is a combustion supporting gas are able to be adjusted according to a combustion effect.

### Example 12

A double chambers boiler system with oxygen-enriched combustion comprises a boiler furnace subassembly 01 and a combustion control subassembly 22; wherein: the boiler furnace subassembly 01 comprises a combustion chamber 02 and a heat exchange chamber 03; the combustion chamber 02, which is a standing combustion chamber, is arranged at a lower part of the boiler furnace subassembly 01, and the heat exchange chamber 03 is arranged at an upper part of the boiler furnace subassembly 01; a high temperature flue gas outlet 10 is arranged between the combustion chamber 02 and the heat exchange chamber 03; and, the combustion control subassembly 22 comprises a burner 04, a pure oxygen injector 08 and a fuel injector 09.

An ash bucket 11 is arranged below the combustion chamber 02; four injection ports 05 are arranged at a middle part of the combustion chamber 02; and the high temperature flue gas outlet 10 is arranged at top of the combustion chamber 02. The injection ports 05 are arranged horizontally and symmetrically. For a wall 07 of the combustion chamber 02, an inner layer is made of high temperature refractory material, a middle layer is made of thermal insulation material, and an outer layer is made of structural material.

The heat exchange chamber 03 is intercommunicated with the combustion chamber 02 through the high temperature flue gas outlet 10; an inner wall of the heat exchange chamber 03 is a water wall 06; a boiler water wall pipe 12 is arranged in middle of the heat exchange chamber 03; a flue gas outlet 15 of the heat exchange chamber 03 is arranged at top of the heat exchange chamber 03; a waste heat recovery device 20 is arranged outside the flue gas outlet 15 of the heat exchange chamber 03; an economizer 21 and a heat exchanger are arranged in middle of the waste heat recovery device 20; an end gas outlet 14 is arranged at a tail end of the waste heat recovery device 20, and the end gas outlet 14 is connected to a pre-heater 13.

In the burner 04, in order to avoid explosion, primary air and secondary air are separately delivered; the primary air and the secondary air are sprayed into the combustion chamber 02 by the burner 04; the primary air is air carrying fuel, and the secondary air is pure oxygen;

all of the primary air is CO₂; CO₂ induced by a draught fan 18 enters the fuel injector 09 after passing through the pre-heater 13; and then the primary air enters the burner 04 with carrying the fuel of the fuel injector 09; herein, the fuel is fed by a fuel supply equipment 16; and

the secondary air is standard pure oxygen; after passing through the pre-heater 13, the standard pure oxygen induced by a draught fan 19 enters the burner 04 through the pure oxygen injector 08.

The combustion control subassembly 22 further comprises a detector 24 for automatically monitoring concentrations of oxygen and CO₂ and a temperature, so that a ratio of CO₂ to flue gas and a ratio of fuel to pure oxygen which is a combustion supporting gas are able to be adjusted according to a combustion effect.

### Example 13

A double chambers boiler system with oxygen-enriched combustion comprises a boiler furnace subassembly 01 and a combustion control subassembly 22; wherein: the boiler furnace subassembly 01 comprises a combustion chamber 02 and a heat exchange chamber 03; the combustion chamber 02, which is a standing combustion chamber, is arranged at a lower part of the boiler furnace subassembly 01, and the heat exchange chamber 03 is arranged at an upper part of the boiler furnace subassembly 01; a high temperature flue gas outlet 10 is arranged between the combustion chamber 02 and the heat exchange chamber 03; and, the combustion control subassembly 22 comprises a burner 04, a pure oxygen injector 08 and a fuel injector 09.

An ash bucket 11 is arranged below the combustion chamber 02; five injection ports 05 are arranged at a middle part of the combustion chamber 02; and the high temperature flue gas outlet 10 is arranged at top of the combustion chamber 02. The injection ports 05 are arranged horizontally and symmetrically. For a wall 07 of the combustion chamber 02, an inner layer is made of high temperature refractory material, a middle layer is made of thermal insulation material, and an outer layer is made of structural material.

The heat exchange chamber 03 is intercommunicated with the combustion chamber 02 through the high temperature flue gas outlet 10; an inner wall of the heat exchange chamber 03 is a water wall 06; a boiler water wall pipe 12 is arranged in middle of the heat exchange chamber 03; a flue gas outlet 15 of the heat exchange chamber 03 is arranged at top of the heat exchange chamber 03; a waste heat recovery device 20 is arranged outside the flue gas outlet 15 of the heat exchange chamber 03; an economizer 21 is arranged in middle of the waste heat recovery device 20; an end gas outlet 14 is arranged at a tail end of the waste heat recovery device 20, and the end gas outlet 14 is connected to a pre-heater 13.

In the burner 04, in order to avoid explosion, primary air and secondary air are separately delivered; the primary air and the secondary air are sprayed into the combustion chamber 02 by the burner 04; the primary air is air carrying fuel, and the secondary air is pure oxygen;

a part of the primary air is end gas exhausted from the waste heat recovery device 20; the end gas exhausted from the waste heat recovery device 20 enters the fuel injector 09 after passing through the pre-heater 13 and processing with flue gas separation, wherein the end gas is induced by a draught fan 17; the other part of the primary air is CO₂; CO₂ induced by a draught fan 18 enters the fuel injector 09 after passing through the pre-heater 13; and then the primary air enters the burner 04 with carrying the fuel of the fuel injector 09; herein, the fuel is fed by a fuel supply equipment 16; and

the secondary air is standard pure oxygen; after passing through the pre-heater 13, the standard pure oxygen induced by a draught fan 19 enters the burner 04 through the pure oxygen injector 08.

The combustion control subassembly 22 further comprises a detector 24 for automatically monitoring concentrations of oxygen and CO₂ and a temperature, so that a ratio of CO₂ to flue gas and a ratio of fuel to pure oxygen which is a combustion supporting gas are able to be adjusted according to a combustion effect.

### Example 14

A double chambers boiler system with oxygen-enriched combustion comprises a boiler furnace subassembly 01 and a combustion control subassembly 22; wherein: the boiler furnace subassembly 01 comprises a combustion chamber 02 and a heat exchange chamber 03; the combustion chamber 02, which is a standing combustion chamber, is arranged at a lower part of the boiler furnace subassembly 01, and the heat exchange chamber 03 is arranged at an upper part of the boiler furnace subassembly 01; a high temperature flue gas outlet 10 is arranged between the combustion chamber 02 and the heat exchange chamber 03; and, the combustion control subassembly 22 comprises a burner 04, a pure oxygen injector 08 and a fuel injector 09.

An ash bucket 11 is arranged below the combustion chamber 02; five injection ports 05 are arranged at a middle part of the combustion chamber 02; and the high temperature flue gas outlet 10 is arranged at top of the combustion chamber 02. The injection ports 05 are arranged horizontally and symmetrically. For a wall 07 of the combustion chamber 02, an inner layer is made of high temperature refractory material, a middle layer is made of thermal insulation material, and an outer layer is made of structural material.

The heat exchange chamber 03 is intercommunicated with the combustion chamber 02 through the high temperature flue gas outlet 10; an inner wall of the heat exchange chamber 03 is a water wall 06; a boiler water wall pipe 12 is arranged in middle of the heat exchange chamber 03; a flue gas outlet 15 of the heat exchange chamber 03 is arranged at top of the heat exchange chamber 03; a waste heat recovery device 20 is arranged outside the flue gas outlet 15 of the heat exchange chamber 03; an economizer 21 and a heat exchanger are arranged in middle of the waste heat recovery device 20; an end gas outlet 14 is arranged at a tail end of the waste heat recovery device 20, and the end gas outlet 14 is connected to a pre-heater 13.

In the burner 04, in order to avoid explosion, primary air and secondary air are separately delivered; the primary air and the secondary air are sprayed into the combustion chamber 02 by the burner 04; the primary air is air carrying fuel, and the secondary air is pure oxygen;

all of the primary air is end gas exhausted from the waste heat recovery device 20; the end gas exhausted from the waste heat recovery device 20 enters the fuel injector 09 after passing through the pre-heater 13 and processing with flue gas separation, wherein the end gas is induced by a draught fan 17; and then the primary air enters the burner 04 with carrying the fuel of the fuel injector 09; herein, the fuel is fed by a fuel supply equipment 16; and

the secondary air is standard pure oxygen; after passing through the pre-heater 13, the standard pure oxygen induced by a draught fan 19 enters the burner 04 through the pure oxygen injector 08.

The combustion control subassembly 22 further comprises a detector 24 for automatically monitoring concentrations of oxygen and CO₂ and a temperature, so that a ratio of CO₂ to flue gas and a ratio of fuel to pure oxygen which is a combustion supporting gas are able to be adjusted according to a combustion effect.

### Example 15

A double chambers boiler system with oxygen-enriched combustion comprises a boiler furnace subassembly 01 and a combustion control subassembly 22; wherein: the boiler furnace subassembly 01 comprises a combustion chamber 02 and a heat exchange chamber 03; the combustion chamber 02, which is a standing combustion chamber, is arranged at a lower part of the boiler furnace subassembly 01, and the heat exchange chamber 03 is arranged at an upper part of the boiler furnace subassembly 01; a high temperature flue gas outlet 10 is arranged between the combustion chamber 02 and the heat exchange chamber 03; and, the combustion control subassembly 22 comprises a burner 04, a pure oxygen injector 08 and a fuel injector 09.

An ash bucket 11 is arranged below the combustion chamber 02; six injection ports 05 are arranged at a middle part of the combustion chamber 02; and the high temperature flue gas outlet 10 is arranged at top of the combustion chamber 02. The injection ports 05 are arranged horizontally and symmetrically. For a wall 07 of the combustion chamber 02, an inner layer is made of high temperature refractory material, a middle layer is made of thermal insulation material, and an outer layer is made of structural material.

The heat exchange chamber 03 is intercommunicated with the combustion chamber 02 through the high temperature flue gas outlet 10; an inner wall of the heat exchange chamber 03 is a water wall 06; a boiler water wall pipe 12 is arranged in middle of the heat exchange chamber 03; a flue gas outlet 15 of the heat exchange chamber 03 is arranged at top of the heat exchange chamber 03; a waste heat recovery device 20 is arranged outside the flue gas outlet 15 of the heat exchange chamber 03; an economizer 21 is arranged in middle of the waste heat recovery device 20; an end gas outlet 14 is arranged at a tail end of the waste heat recovery device 20, and the end gas outlet 14 is connected to a pre-heater 13.

In the burner 04, in order to avoid explosion, primary air and secondary air are separately delivered; the primary air and the secondary air are sprayed into the combustion chamber 02 by the burner 04; the primary air is air carrying fuel, and the secondary air is pure oxygen;

all of the primary air is end gas exhausted from the waste heat recovery device 20; the end gas exhausted from the waste heat recovery device 20 enters the fuel injector 09 after passing through the pre-heater 13 and processing with flue gas separation, wherein the end gas is induced by a draught fan 17; and then the primary air enters the burner 04 with carrying the fuel of the fuel injector 09; herein, the fuel is fed by a fuel supply equipment 16; and

the secondary air is standard pure oxygen; after passing through the pre-heater 13, the standard pure oxygen induced by a draught fan 19 enters the burner 04 through the pure oxygen injector 08.

The combustion control subassembly 22 further comprises a detector 24 for automatically monitoring concentrations of oxygen and CO₂ and a temperature, so that a ratio of CO₂ to flue gas and a ratio of fuel to pure oxygen which is a combustion supporting gas are able to be adjusted according to a combustion effect.

### Example 16

A double chambers boiler system with oxygen-enriched combustion comprises a boiler furnace subassembly 01 and a combustion control subassembly 22; wherein: the boiler furnace subassembly 01 comprises a combustion chamber 02 and a heat exchange chamber 03; the combustion chamber 02, which is a standing combustion chamber, is arranged at a lower part of the boiler furnace subassembly 01, and the heat exchange chamber 03 is arranged at an upper part of the boiler furnace subassembly 01; a high temperature flue gas outlet 10 is arranged between the combustion chamber 02 and the heat exchange chamber 03; and, the combustion control subassembly 22 comprises a burner 04, a pure oxygen injector 08 and a fuel injector 09.

An ash bucket 11 is arranged below the combustion chamber 02; six injection ports 05 are arranged at a middle part of the combustion chamber 02; and the high temperature flue gas outlet 10 is arranged at top of the combustion chamber 02. The injection ports 05 are arranged horizontally and symmetrically. For a wall 07 of the combustion chamber 02, an inner layer is made of high temperature refractory material, a middle layer is made of thermal insulation material, and an outer layer is made of structural material.

The heat exchange chamber 03 is intercommunicated with the combustion chamber 02 through the high temperature flue gas outlet 10; an inner wall of the heat exchange chamber 03 is a water wall 06; a boiler water wall pipe 12 is arranged in middle of the heat exchange chamber 03; a flue gas outlet 15 of the heat exchange chamber 03 is arranged at top of the heat exchange chamber 03; a waste heat recovery device 20 is arranged outside the flue gas outlet 15 of the heat exchange chamber 03; an economizer 21 and a heat exchanger are arranged in middle of the waste heat recovery device 20; an end gas outlet 14 is arranged at a tail end of the waste heat recovery device 20, and the end gas outlet 14 is connected to a pre-heater 13.

In the burner 04, in order to avoid explosion, primary air and secondary air are separately delivered; the primary air and the secondary air are sprayed into the combustion chamber 02 by the burner 04; the primary air is air carrying fuel, and the secondary air is pure oxygen;

a part of the primary air is end gas exhausted from the waste heat recovery device 20; the end gas exhausted from the waste heat recovery device 20 enters the fuel injector 09 after passing through the pre-heater 13 and processing with flue gas separation, wherein the end gas is induced by a draught fan 17; the other part of the primary air is CO₂; CO₂ induced by a draught fan 18 enters the fuel injector 09 after passing through the pre-heater 13; and then the primary air enters the burner 04 with carrying the fuel of the fuel injector 09; herein, the fuel is fed by a fuel supply equipment 16; and

the secondary air is standard pure oxygen; after passing through the pre-heater 13, the standard pure oxygen induced by a draught fan 19 enters the burner 04 through the pure oxygen injector 08.

The combustion control subassembly 22 further comprises a detector 24 for automatically monitoring concentrations of oxygen and CO₂ and a temperature, so that a ratio of CO₂ to flue gas and a ratio of fuel to pure oxygen which is a combustion supporting gas are able to be adjusted according to a combustion effect.

1. A double chambers boiler system with oxygen-enriched combustion, comprising a boiler furnace subassembly (01) and a combustion control subassembly (22); wherein:
the boiler furnace subassembly (01) comprises a combustion chamber (02) and a heat exchange chamber (03); the combustion chamber (02) is for oxygen-enriched combustion of fuel, so as to generate high temperature flue gas; the heat exchange chamber (03) is for transferring heat from the high temperature flue gas; the heat exchange chamber (03) is arranged above the combustion chamber (02); a high temperature flue gas outlet (10) is arranged between the combustion chamber (02) and the heat exchange chamber (03); pure oxygen is adopted for supporting combustion; the combustion chamber (02) is able to meet a high temperature resistance requirement for combustion in the pure oxygen; and the heat exchange chamber (03) is able to realize a highly-efficient heat transfer of a boiler.

2. The double chambers boiler system with oxygen-enriched combustion, as recited in claim 1, wherein: the combustion control subassembly (22) assists feeding of the fuel with CO₂ and/or flue gas recirculation and is equipped with a flue gas recirculation tube (23); according to a combustion effect in the combustion chamber (02), a ratio of CO₂ to flue gas and a ratio of fuel to pure oxygen which is a combustion supporting gas are able to be adjusted by the combustion control subassembly (22); and, the combustion control subassembly (22) comprises a burner (04), a pure oxygen injector (08) and a fuel injector (09).

3. The double chambers boiler system with oxygen-enriched combustion, as recited in claim 2, wherein: injection ports (05) are arranged at a middle part of the combustion chamber (02) and on a wall (07) of the combustion chamber (02); the injection ports (05) are arranged horizontally and symmetrically on a same plane, and 3-6 injection ports (05) are arranged on the same plane; for the wall (07) of the combustion chamber (02), an inner layer is made of high temperature refractory material, a middle layer is made of thermal insulation material, and an outer layer is made of structural material; and an ash bucket (11) is arranged below the combustion chamber (02).

4. The double chambers boiler system with oxygen-enriched combustion, as recited in claim 2, wherein: the heat exchange chamber (03) is intercommunicated with the combustion chamber (02) through the high temperature flue gas outlet (10); a flue gas outlet (15) of the heat exchange chamber (03) is arranged at top of the heat exchange chamber (03); a waste heat recovery device (20) is arranged outside the flue gas outlet (15) of the heat exchange chamber (03); an inner wall of the heat exchange chamber (03) is a water wall (06); and a boiler water wall pipe (12) is arranged in middle of the heat exchange chamber (03).

5. The double chambers boiler system with oxygen-enriched combustion, as recited in claim 4, wherein: an economizer (21) is arranged inside the waste heat recovery device (20); an end gas outlet (14) is arranged at a tail end of the waste heat recovery device (20), and the end gas outlet (14) is connected to a pre-heater (13).

6. The double chambers boiler system with oxygen-enriched combustion, as recited in claim 2, wherein: in the burner (04), in order to avoid explosion, primary air and secondary air are separately delivered; the primary air and the secondary air are sprayed into the combustion chamber (02) by the burner (04); the primary air is air carrying the fuel, and the secondary air is the pure oxygen.

7. The double chambers boiler system with oxygen-enriched combustion, as recited in claim 6, wherein: a part of or all of the primary air is end gas exhausted from a waste heat recovery device (20); the end gas exhausted from the waste heat recovery device (20) enters the fuel injector (09) after passing through a pre-heater (13) and processing with flue gas separation; and then the primary air carrying the fuel enters the burner (04);
when a part of the primary air is the end gas exhausted from the waste heat recovery device (20), the other part of the primary air is CO₂; the end gas and CO₂ enter the fuel injector (09) after passing through the pre-heater (13); and then the primary air carrying the fuel enters the burner (04); or
all of the primary air is CO₂; CO₂ enters the fuel injector (09) after passing through the pre-heater (13); and then the primary air carrying the fuel enters the burner (04); and
the secondary air is standard pure oxygen; after passing through the pre-heater (13), the standard pure oxygen enters the burner (04) through the pure oxygen injector (08).

8. The double chambers boiler system with oxygen-enriched combustion, as recited in claim 7, wherein: internal channels of the burner (04) are arranged in structure of concentric circles or parallel channels, comprising an oxygen channel (201) and a fuel channel (202); the oxygen channel (201) and the fuel channel (202) are separated from each other; the primary air carrying the fuel is sprayed into the combustion chamber (02) through the fuel channel (202), and the secondary air enters the combustion chamber (02) through the oxygen channel (201).

9. The double chambers boiler system with oxygen-enriched combustion, as recited in claim 1, wherein: the combustion control subassembly (22) further comprises a detector (24) for automatically monitoring concentrations of oxygen and CO₂ and a temperature, so that a ratio of CO₂ to flue gas and a ratio of fuel to pure oxygen which is a combustion supporting gas are able to be adjusted according to a combustion effect in the combustion chamber (02).
